(19) United States
(12) Patent Application Publication
(10) Pub. No.: US 2026/0269685 A1
(43) Pub. Date: Sep. 10, 2026

(54) MOTOR DEVICE

(71) Applicant: MITSUBA Corporation, Gunma (JP)

(72) Inventors: YUTARO JO, Gunma (JP); YASUSHI YOSHIDA, Gunma (JP); TERUMASA HOSHINO, Gunma (JP)

(73) Assignee: MITSUBA Corporation, Gunma (JP)

(21) Appl. No.: 19/166,032

(22) PCT Filed: Nov. 26, 2024
(86) PCT No.: PCT/JP2024/041711

§ 371 Date: Sep. 16, 2025

(30) Foreign Application Priority Data
Nov. 29, 2023 (JP) 2023-201164

(51) Int. Cl. H02K 7/116; F16H 57/00; F16H 57/02; F16H 57/021

(52) U.S. Cl. CPC H02K 7/1166; F16H 57/0006; F16H 57/021; F16H 2057/02034; F16H 2057/02082

(57) ABSTRACT

In a motor device, a ground terminal is provided to be clamped between a motor case and a gear case, and electrical noise generated due to rotation of a rotating shaft flows through the ground terminal. First to third fixing parts disposed around the rotating shaft and composed of first to third motor case-side abutting surfaces and first to third gear case-side abutting surfaces abutted against each other are provided between the motor case and the gear case. The ground terminal is disposed only between the second fixing part and the third fixing part which form a shortest line segment among line segments connecting the first to third fixing parts adjacent to each other in a circumferential direction of the rotating shaft.

### TECHNICAL FIELD

The present invention relates to a motor device that includes a rotating shaft and a gear rotated by the rotating shaft.

### BACKGROUND ART

For example, Patent Document 1 describes an electric motor that includes an armature shaft, a worm rotated by the armature shaft, and a worm wheel rotated by the worm. The armature shaft is accommodated in a yoke, and the worm and the worm wheel are accommodated in a casing. An annular contact plate is clamped between the yoke and the casing, and the contact plate has a function of releasing electrical noise transmitted to the armature shaft to ground.

### RELATED ART DOCUMENTS

### Patent Documents

Patent Document 1: Japanese Patent No. 6051129

### SUMMARY OF INVENTION

### Problem to be Solved by Invention

However, in the technique described in Patent Document 1, there is a problem that, in the case of variations in the molding accuracy of the contact plate or variations in the tightening torque of screws fixing the yoke and the casing to each other, the axis of the armature shaft and the axis of the worm become misaligned, and operating noise increases.

An objective of the present invention is to provide a motor device capable of reducing operating noise while improving assemblability.

### Means for Solving Problem

In an aspect of the present invention, a motor device includes a rotating shaft and a gear rotated by the rotating shaft, and includes: a motor case accommodating the rotating shaft; a gear case accommodating the gear; and a conductive member that is clamped between the motor case and the gear case and through which electrical noise generated due to rotation of the rotating shaft flows. At least three fixing parts disposed around the rotating shaft and each composed of a pair of abutting surfaces abutted against each other are provided between the motor case and the gear case. The conductive member is disposed only between the fixing parts that form a shortest line segment among line segments connecting the fixing parts adjacent to each other in a circumferential direction of the rotating shaft.

### Effects of Invention

According to the present invention, it is possible to realize a motor device capable of reducing operating noise while improving assemblability.

### BRIEF DESCRIPTION OF THE DRAWINGS

FIG. 1 is a schematic view of a sunroof device installed at a roof of a vehicle.

FIG. 2 is a perspective view showing an output gear side of a sunroof motor.

FIG. 3 is a perspective view showing a cover member side of the sunroof motor.

FIG. 4 is a cross-sectional view of the sunroof motor taken along an axial direction of a rotating shaft.

FIG. 5 is a perspective view of a motor case viewed from a flange part side.

FIG. 6 is a perspective view of a gear case viewed from a motor accommodating part side.

FIG. 7 is a plan view of the gear case viewed from the motor accommodating part side.

FIG. 8 is an arrow view in a direction of A in FIG. 6.

FIG. 9 is a perspective view showing a ground terminal alone.

FIG. 10 is an exploded perspective view of the sunroof motor (internal structure omitted).

FIG. 11 is a view illustrating an assembly procedure (1) of the sunroof motor.

FIG. 12 is a view illustrating an assembly procedure (2) of the sunroof motor.

FIG. 13 is a view illustrating an assembly procedure (3) of the sunroof motor.

FIG. 14 is a view corresponding to FIG. 11 showing Embodiment 2.

### EMBODIMENTS FOR IMPLEMENTING INVENTION

### Embodiment 1

Hereinafter, Embodiment 1 of the present invention will be described in detail with reference to the drawings.

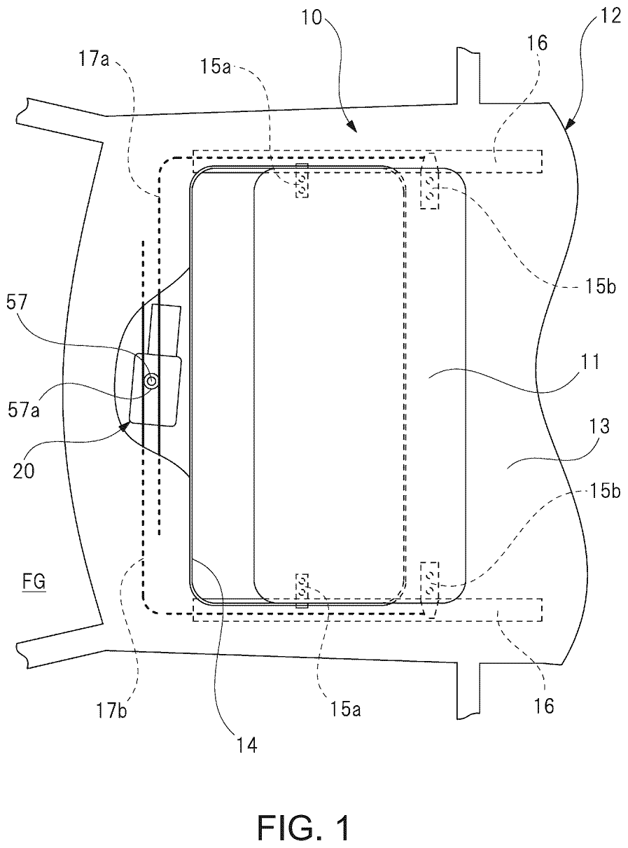

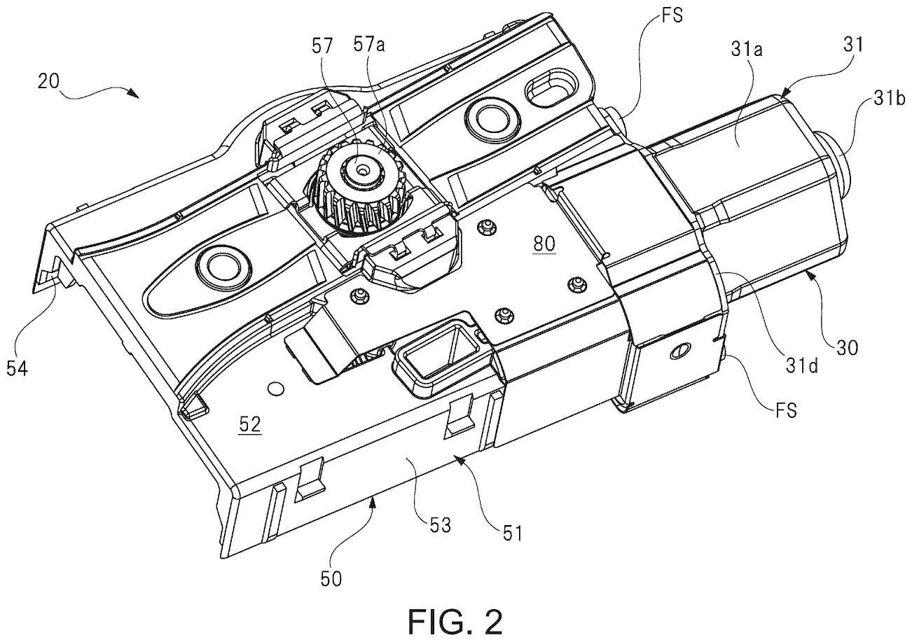

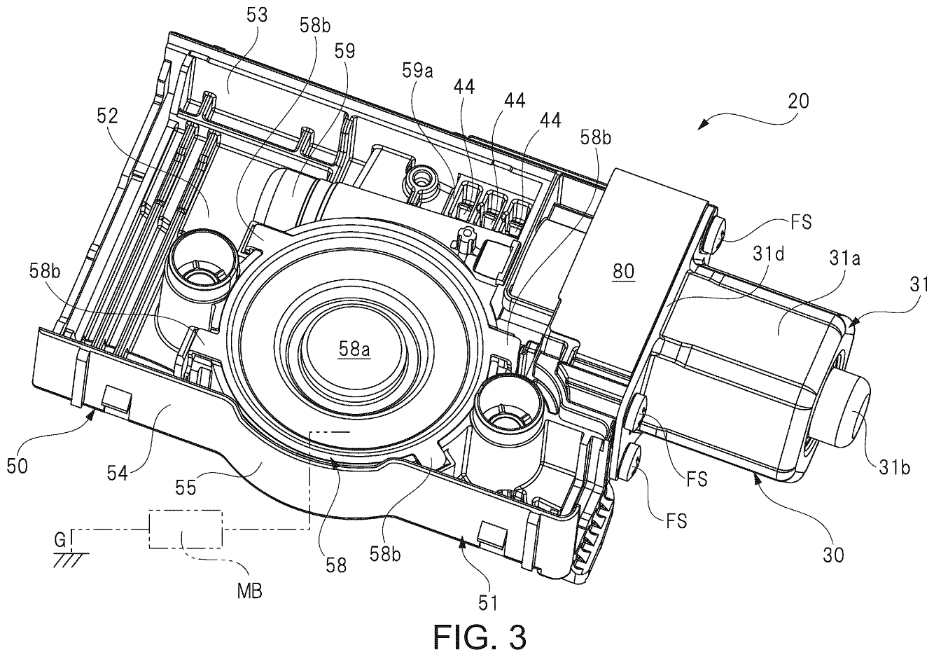

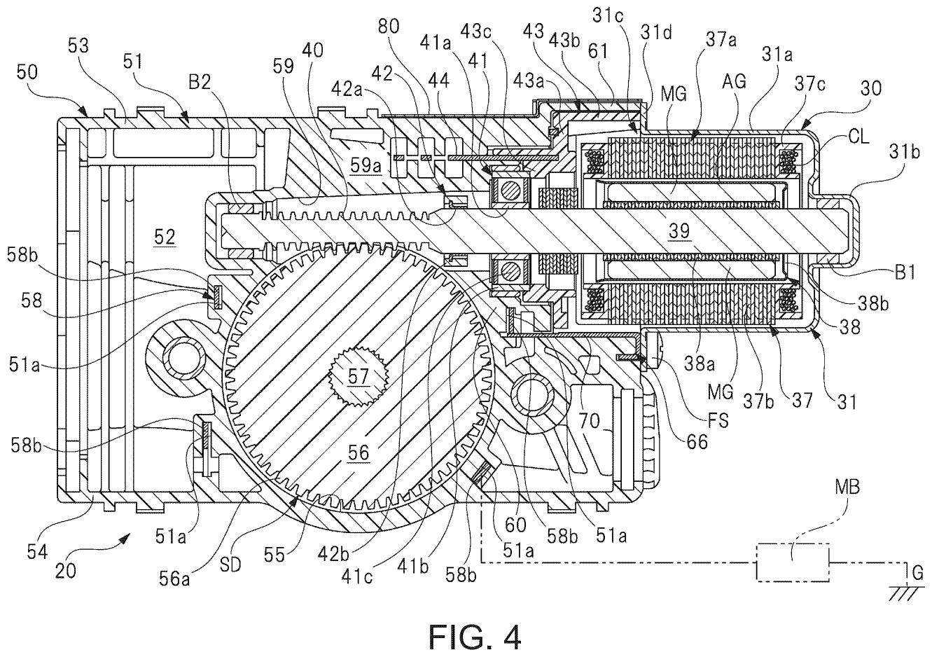

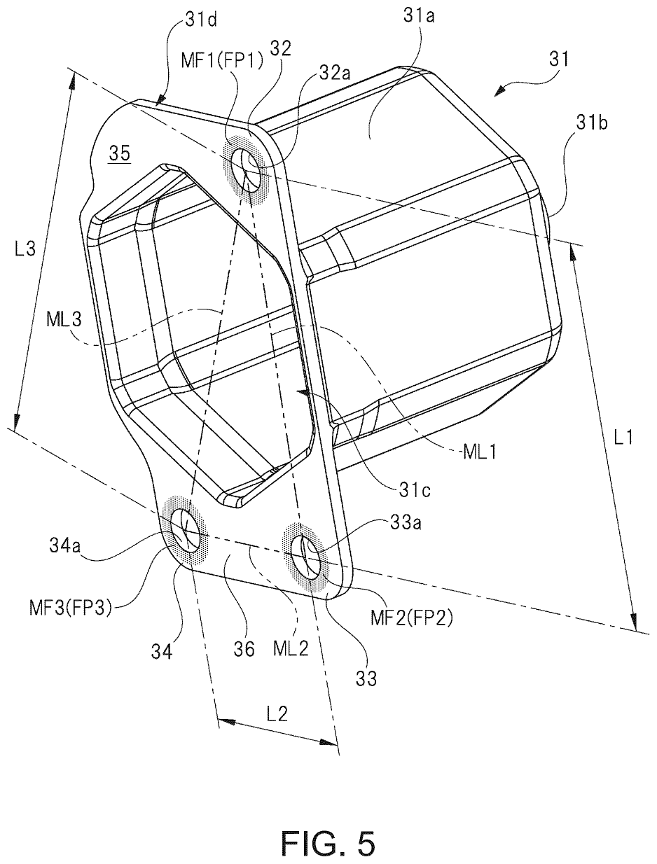

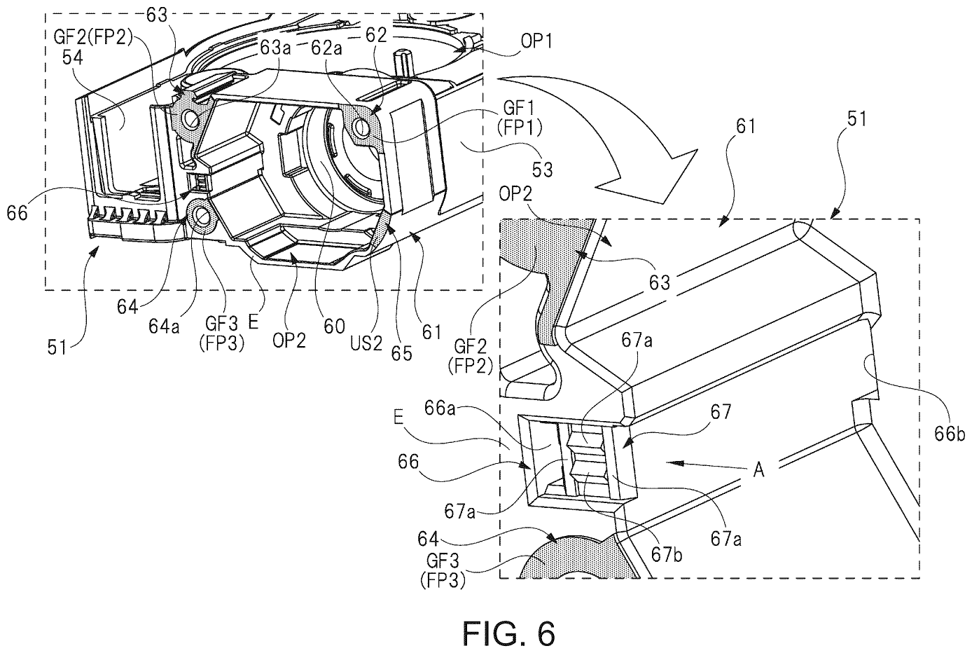

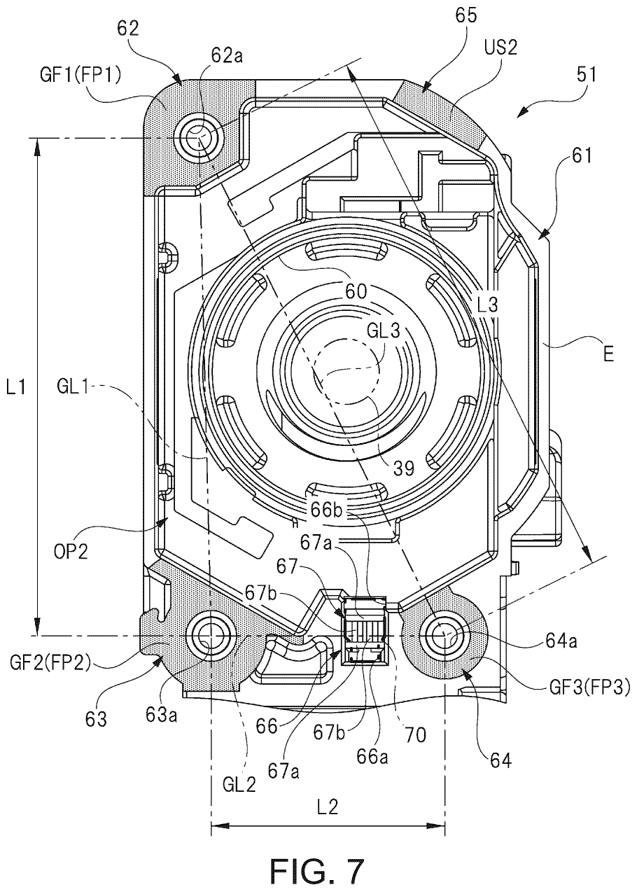

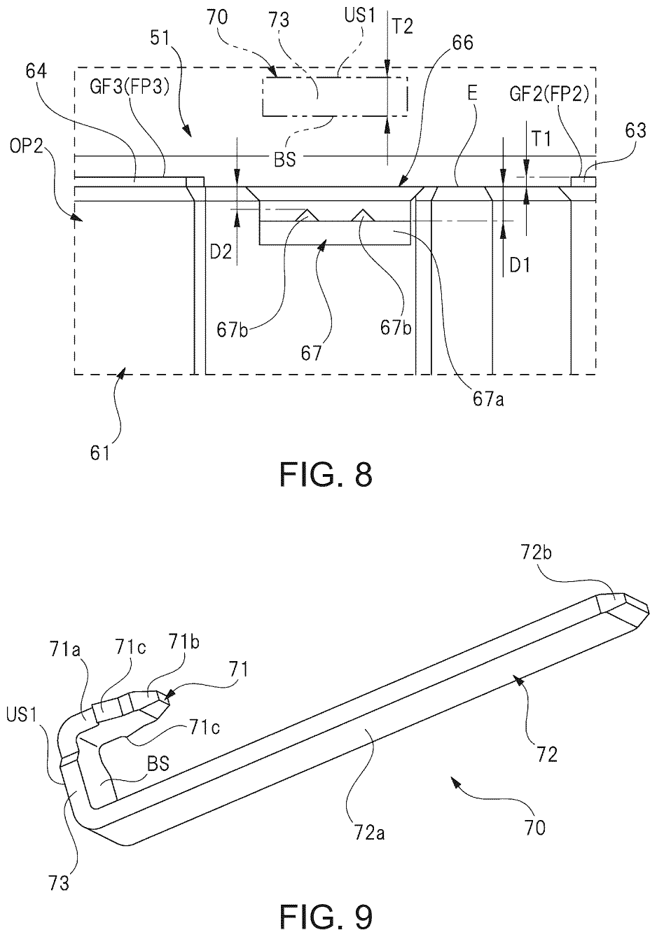

FIG. 1 is a schematic view of a sunroof device installed at a roof of a vehicle. FIG. 2 is a perspective view showing an output gear side of a sunroof motor. FIG. 3 is a perspective view showing a cover member side of the sunroof motor. FIG. 4 is a cross-sectional view of the sunroof motor taken along an axial direction of a rotating shaft. FIG. 5 is a perspective view of a motor case viewed from a flange part side. FIG. 6 is a perspective view of a gear case viewed from a motor accommodating part side. FIG. 7 is a plan view of the gear case viewed from the motor accommodating part side. FIG. 8 is an arrow view in a direction of A in FIG. 6. FIG. 9 is a perspective view showing a ground terminal alone.

### [Overview of Sunroof Device]

As shown in FIG. 1, a sunroof device 10 includes a roof panel 11. The roof panel 11 opens and closes a roof opening 14 formed at a roof 13 of a vehicle 12. Pairs of shoes 15a and 15b are fixed respectively on both sides (upper and lower sides in FIG. 1) in a vehicle width direction of the roof panel 11.

In addition, guide rails 16 extending in a front-rear direction (left-right direction in FIG. 1) of the vehicle 12 are respectively fixed on both sides in the vehicle width direction of the roof opening 14 in the roof 13. The pairs of shoes 15a and 15b are respectively guided by the pair of guide rails 16, and the roof panel 11 moves in the front-rear direction of the vehicle 12.

Furthermore, one-side ends of drive cables 17a and 17b with gears are connected respectively to the pair of shoes 15b disposed on a rear side (right side in FIG. 1) of the vehicle 12. On the other hand, other-side ends of the pair of drive cables 17a and 17b are routed to a front side (left side in FIG. 1) of the vehicle 12 beyond the roof opening 14.

In addition, in the front-rear direction of the vehicle 12, a sunroof motor 20 is installed inside the roof 13 between a windshield FG and the roof opening 14. The other-side ends of the pair of drive cables 17a and 17b are meshed with an output gear 57a provided at the sunroof motor 20.

Accordingly, upon driving of the sunroof motor 20, the pair of drive cables 17a and 17b move in longitudinal directions thereof in directions opposite to each other. Thus, the roof panel 11 is pushed and pulled by the pair of drive cables 17a and 17b via the pair of shoes 15b to open and close the roof opening 14.

The sunroof motor 20 corresponds to a motor device in the present invention.

### [Sunroof Motor]

As shown in FIG. 2 to FIG. 4, the sunroof motor 20 is formed in a flat, substantially rectangular parallelepiped shape and is thus capable of being installed inside the narrow roof 13 (see FIG. 1). The sunroof motor 20 includes an electric motor part 30 and a reduction mechanism part 50, and the electric motor part 30 and the reduction mechanism part 50 are fixed to each other by a total of three fixing screws FS.

Herein, in the present embodiment, the electric motor part 30 is a brushless motor.

However, as the electric motor part 30, a brushed electric motor may also be adopted.

### [Motor Case]

As shown in FIG. 2 to FIG. 5, the electric motor part 30 includes a motor case 31 that forms an outer shell of the electric motor part 30. The motor case 31 is made of metal and is formed in a bottomed tubular shape by subjecting a steel plate to deep drawing.

An axial base side (right side in FIG. 4) of a rotating shaft 39 is rotatably accommodated inside the motor case 31. A cross-section of the motor case 31 along a direction orthogonal to the axial direction of the rotating shaft 39 has a sidewall part 31a formed in a substantially regular hexagonal shape. In addition, a stepped bottom wall part 31b is integrally provided on one axial side (right side in FIG. 4) of the sidewall part 31a.

Furthermore, a motor case-side opening 31c is provided on the other axial side (left side in FIG. 4) of the sidewall part 31a. In addition, a flange part 31d is integrally provided to surround the motor case-side opening 31c on the other axial side of the sidewall part 31a.

### [Flange Part]

As shown in FIG. 5, the flange part 31d expands in a direction orthogonal to the axial direction of the rotating shaft 39 and is disposed around the motor case-side opening 31c. Specifically, the flange part 31d is formed in a substantially rectangular shape when viewed from the axial direction of the rotating shaft 39. At the four corner parts forming the flange part 31d, a first motor case-side corner part 32, a second motor case-side corner part 33, a third motor case-side corner part 34, and a motor case-side abutting part 35 are respectively provided.

The first motor case-side corner part 32 has a first motor case-side abutting surface MF1 (see a hatched part in FIG. 5) on a side (gear case 51 side) opposite to the bottom wall part 31b side in the axial direction of the motor case 31. The first motor case-side abutting surface MF1 is a portion that is abutted against a first gear case-side abutting surface GF1 (see FIG. 6 and FIG. 7) of a gear case 51 in the axial direction of the rotating shaft 39. The first motor case-side corner part 32 is provided with a first screw insertion hole 32a through which a fixing screw FS is inserted.

The second motor case-side corner part 33 has a second motor case-side abutting surface MF2 (see a hatched part in FIG. 5) on the side (gear case 51 side) opposite to the bottom wall part 31b side in the axial direction of the motor case 31. The second motor case-side abutting surface MF2 is a portion that is abutted against a second gear case-side abutting surface GF2 (see FIG. 6 and FIG. 7) of the gear case 51 in the axial direction of the rotating shaft 39. The second motor case-side corner part 33 is provided with a second screw insertion hole 33a through which a fixing screw FS is inserted.

The third motor case-side corner part 34 has a third motor case-side abutting surface MF3 (see a hatched part in FIG. 5) on the side (gear case 51 side) opposite to the bottom wall part 31b side in the axial direction of the motor case 31. The third motor case-side abutting surface MF3 is a portion that is abutted against a third gear case-side abutting surface GF3 (see FIG. 6 and FIG. 7) of the gear case 51 in the axial direction of the rotating shaft 39. The third motor case-side corner part 34 is provided with a third screw insertion hole 34a through which a fixing screw FS is inserted.

The total of three motor case-side abutting surfaces, i.e., the first, second, and third motor case-side abutting surfaces MF1, MF2, and MF3, provided at the flange part 31d of the motor case 31 are provided between the motor case 31 and the gear case 51, and respectively correspond to an abutting surface in the present invention.

In addition, the motor case-side abutting part 35 is a portion that is abutted against a gear case-side abutting part 65 (see FIG. 6 and FIG. 7) of the gear case 51 in the axial direction of the rotating shaft 39. The motor case-side abutting part 35 is disposed at a position opposed to the second motor case-side corner part 33 with the motor case-side opening 31c as the center.

Herein, the flange part 31d expands with high accuracy without distortion in a direction orthogonal to the axial direction (left-right direction in FIG. 4) of the motor case 31. Specifically, after forming the motor case 31 by deep drawing, by further subjecting the flange part 31d to pressing (secondary processing), the flatness of the flange part 31d is enhanced. Accordingly, the first, second, and third motor case-side abutting surfaces MF1, MF2, and MF3 and the motor case-side abutting part 35 are abutted against the gear case 51 without rattling. Thus, the motor case 31 and the gear case 51 can be disposed straight and coaxially with each other.

As shown in FIG. 5, a first motor case-side line segment ML1, which connects the first motor case-side abutting surface MF1 having the first screw insertion hole 32a disposed at the center and the second motor case-side abutting surface MF2 having the second screw insertion hole 33a disposed at the center, extends in the width direction (up-down direction in FIG. 4) of the sunroof motor 20.

In addition, a second motor case-side line segment ML2, which connects the second motor case-side abutting surface MF2 having the second screw insertion hole 33a disposed at the center and the third motor case-side abutting surface MF3 having the third screw insertion hole 34a disposed at the center, extends in the thickness direction (depth direction in FIG. 4) of the sunroof motor 20.

Furthermore, a third motor case-side line segment ML3, which connects the first motor case-side abutting surface MF1 having the first screw insertion hole 32a disposed at the center and the third motor case-side abutting surface MF3 having the third screw insertion hole 34a disposed at the center, extends to cross a substantially axial center part of the motor case 31, i.e., a substantially central part of the motor case-side opening 31c.

In this manner, the first, second, and third motor case-side abutting surfaces MF1, MF2, and MF3 and the motor case-side abutting part 35 are disposed around the rotating shaft 39 with the motor case-side opening 31c as the center.

The first, second, and third motor case-side line segments ML1, ML2, and ML3 form an isosceles triangle, and the size relationship of length dimensions L1, L2, and L3 of the first, second, and third motor case-side line segments ML1, ML2, and ML3 is L3>L1>L2.

In addition, a pressing part 36 that presses a ground terminal 70 (see FIG. 9) toward the gear case 51 is provided between the second motor case-side corner part 33 and the third motor case-side corner part 34 of the flange part 31d. That is, the ground terminal 70 is disposed only between the second motor case-side abutting surface MF2 and the third motor case-side abutting surface MF3 forming the second motor case-side line segment ML2, which is shortest among the first, second, and third motor case-side line segments ML1, ML2, and ML3 connecting the first, second, and third motor case-side abutting surfaces MF1, MF2, and MF3 adjacent to each other in the circumferential direction of the rotating shaft 39.

The ground terminal 70 has a rod shape extending in the axial direction of the rotating shaft 39 and is disposed only between the second motor case-side abutting surface MF2 and the third motor case-side abutting surface MF3.

Accordingly, the pressing part 36 is disposed only on the shortest second motor case-side line segment ML2 when viewing the sunroof motor 20 from the axial direction of the rotating shaft 39. Therefore, when fixing the motor case 31 to the gear case 51 using the fixing screws FS, the pressing part 36 does not deform and can reliably press the ground terminal 70. Thus, the ground terminal 70 is disposed between the second motor case-side abutting surface MF2 and the third motor case-side abutting surface MF3 and overlaps with the pressing part 36 when viewing the sunroof motor 20 from the axial direction of the rotating shaft 39.

Pressed by the pressing part 36, the ground terminal 70 is electrically connected to the motor case 31. In addition, the first, second, and third motor case-side line segments ML1, ML2, and ML3 each correspond to a line segment in the present invention.

### [Stator]

As shown in FIG. 4, a stator 37 is accommodated inside the sidewall part 31a forming the motor case 31. The stator 37 has a stator core 37a formed by laminating multiple thin steel plates. The stator core 37a is fixed to the inner side of the sidewall part 31a and includes a total of six teeth 37b (not shown in detail). Three-phase coils CL composed of the U-phase, the V-phase, and the W-phase are respectively wound around these teeth 37b via an insulator 37c.

### [Rotor]

As shown in FIG. 4, a rotor 38 is rotatably provided on the radially inner side of the stator 37 via an air gap AG. The rotor 38 has a rotor core 38a formed in a substantially tubular shape. The rotor core 38a is formed by laminating multiple thin steel plates, and a total of four magnets MG are mounted on an outer circumferential part of the rotor core 38a. Specifically, the respective magnets MG are disposed at equal intervals (90-degree intervals) in the circumferential direction of the rotor core 38a.

In addition, the outer circumferential parts of the respective magnets MG mounted on the rotor core 38a are covered by a magnet holder 38b formed of a thin stainless steel plate or the like into a substantially tubular shape. The magnet holder 38b has a function of fixing the magnets MG to the rotor core 38a. Accordingly, even if the rotor 38 rotates at a high speed, the magnets MG do not fall off from the rotor core 38a due to the centrifugal force at that time.

### [Rotating Shaft]

A rotating shaft 39 is fixed by press-fitting to the rotation center of the rotor core 38a. That is, the sunroof motor 20 includes the rotating shaft 39. The rotating shaft 39 is made of a round steel bar to ensure sufficient strength.

The axial base side (right side in FIG. 4) of the rotating shaft 39 is accommodated inside the motor case 31 and is rotatably supported by a first radial bearing B1 provided at the bottom wall part 31b of the motor case 31. On the other hand, the axial tip side (left side in FIG. 4) of the rotating shaft 39 is accommodated inside the gear case 51 which forms the reduction mechanism part 50 and is rotatably supported by a second radial bearing B2 provided at a worm accommodating part 59 of the gear case 51.

In this manner, in the present embodiment, the rotating shaft 39 is rotatably accommodated in both the motor case 31 and the gear case 51. Thus, to smoothly rotate the rotating shaft 39, it is important to dispose the motor case 31 and the gear case 51 coaxially with each other with high accuracy.

In addition, a worm 40 that forms a reduction mechanism SD is integrally provided on the axial tip side of the rotating shaft 39 by rolling or the like. That is, the worm 40 is also made of the round steel bar. Accordingly, the rigidity of the worm 40 is enhanced and the worm 40 does not curve. Thus, the worm 40 is reliably meshed with a worm wheel 56.

### [Ball Bearing]

A ball bearing 41 is mounted at an axial central part of the rotating shaft 39. That is, the ball bearing 41 is provided between the first radial bearing B1 and the second radial bearing B2 in the axial direction of the rotating shaft 39, and rotatably supports the axial central part of the rotating shaft 39. Specifically, the rotor core 38a to which the magnets MG are fixed is disposed between the ball bearing 41 and the first radial bearing B1, and the worm 40 is disposed between the ball bearing 41 and the second radial bearing B2.

Similar to the first radial bearing B1 and the second radial bearing B2, the ball bearing 41 rotatably supports the rotating shaft 39, and includes an inner race 41a and an outer race 41b. In addition, multiple balls 41c are provided between the inner race 41a and the outer race 41b.

The inner race 41a is fixed to the rotating shaft 39 by press fitting. That is, the inner race 41a is rotated together with the rotating shaft 39.

### [Sensor Magnet Unit]

In the axial direction of the rotating shaft 39, a sensor magnet unit 42 is provided between the worm 40 and the ball bearing 41. The sensor magnet unit 42 includes a bracket member 42a in a tubular shape that is fixed to the rotating shaft 39 by press fitting, and a sensor magnet 42b that is held by the bracket member 42a. Herein, the sensor magnet 42b is used to detect a rotation state, specifically, a rotational direction, a rotational speed, etc. of the rotating shaft 39 (rotor 38).

Similar to the inner race 41a of the ball bearing 41, the sensor magnet unit 42 is also rotated together with the rotating shaft 39.

### [Holder Member]

In addition, the electric motor part 30 includes a holder member 43. The holder member 43 is composed of a resin material such as plastic, and includes a support body 43a formed in a substantially flat plate shape, and a wall part 43b that enters the gear case 51. That is, the holder member 43 is a component that is mounted to the gear case 51.

The support body 43a of the holder member 43 is integrally provided with an annular support part 43c. The annular support part 43c supports the outer race 41b of the ball bearing 41 from the one axial side (right side in FIG. 4). The other axial side (left side in FIG. 4) of the outer race 41b is supported by a bearing mounting part 60 provided at the gear case 51.

In this manner, the outer race 41b of the ball bearing 41 is clamped between the gear case 51 and the holder member 43 in the axial direction of the rotating shaft 39. The holder member 43 is fixed inside the gear case 51 without rattling by fixing the motor case 31 to the gear case 51 with a total of three fixing screws FS.

Three conductors 44 (see FIG. 3) are mounted to the support body 43a in correspondence with the three-phase coils CL. The conductors 44 are formed of brass or the like having excellent conductivity into a substantially rod shape, and extend in the axial direction of the rotor 38. One longitudinal side (right side in FIG. 4) of the conductors 44 is electrically connected to the three-phase coils CL, and the other longitudinal side (left side in FIG. 4) of the conductors 44 is supported by a conductor support part 59a of the gear case 51.

A motor board MB is electrically connected to the other longitudinal side of the conductors 44 (not shown in detail), and connection terminals of an external connector (not shown) provided on the vehicle 12 (see FIG. 1) side are electrically connected to the motor board MB. Thus, a drive current is supplied from an in-vehicle controller or the like to the three-phase coils CL of the sunroof motor 20, and the rotating shaft 39 is rotated in forward and reverse directions.

Herein, the motor board MB is actually mounted on a side (see FIG. 3) where the cover member 58 of the gear case 51 is provided. That is, the motor board MB is provided to overlap the cover member 58 in the axial direction of the output shaft 57 (see FIG. 2). The cover member 58 is electrically connected to both the motor board MB and the ground terminal 70. In addition, the motor board MB is connected (grounded) to a body of the vehicle 12 which serves as a reference potential, as indicated by a reference sign G in FIG. 3 and FIG. 4.

Thus, electrical noise generated during rotation of the rotating shaft 39 flows from the motor case 31 through the ground terminal 70, and is released to the body of the vehicle 12 via the cover member 58 and the motor board MB. Accordingly, radiation of electrical noise around the sunroof motor 20 is suppressed, and thus adverse effects on other in-vehicle equipment (car audio and the like) can be avoided.

### [Gear Case]

As shown in FIG. 2 to FIG. 4 and FIG. 6 to FIG. 8, the reduction mechanism part 50 includes a gear case 51 which accommodates the reduction mechanism SD. The gear case 51 is formed of a resin material such as plastic into a flat, substantially rectangular parallelepiped shape, and is abutted with the motor case 31 in the axial direction of the rotating shaft 39. Specifically, the gear case 51 made of resin has a first wall part 52, a second wall part 53, and a third wall part 54.

As shown in FIG. 4, a worm wheel accommodating part 55 is provided on the inner side of the gear case 51. The worm wheel accommodating part 55 is arranged alongside the third wall part 54 in the axial direction of the rotating shaft 39. A worm wheel 56 that forms the reduction mechanism SD is rotatably accommodated inside the worm wheel accommodating part 55. Herein, the worm wheel 56 is provided with a tooth part 56a, and the tooth part 56a is meshed with the worm 40 inside the gear case 51.

In this manner, the reduction mechanism SD is a worm reduction mechanism capable of obtaining a relatively large reduction ratio. In the present embodiment, the reduction ratio of the reduction mechanism SD is “1/67”. That is, the reduction ratio is such that the worm wheel 56 gradually rotates once with the worm 40 rotating 67 times. Of course, other reduction ratios may also be set.

In addition, the axial base side of the output shaft 57 composed of a round steel bar is fixed to the rotation center of the worm wheel 56. In contrast, the output gear 57a (see FIG. 2) with which the pair of drive cables 17a and 17b (see FIG. 1) are meshed is integrally provided on the axial tip side of the output shaft 57.

Accordingly, the high-speed rotation of the rotating shaft 39 is decelerated by the reduction mechanism SD, and the decelerated rotational force with an increased torque is transmitted to the pair of drive cables 17a and 17b via the output shaft 57 and the output gear 57a. Herein, the reduction mechanism SD is formed of the worm 40 and the worm wheel 56.

The worm 40 and the worm wheel 56 are rotatably accommodated inside the gear case 51 and rotated by the rotating shaft 39, and each correspond to a gear in the present invention.

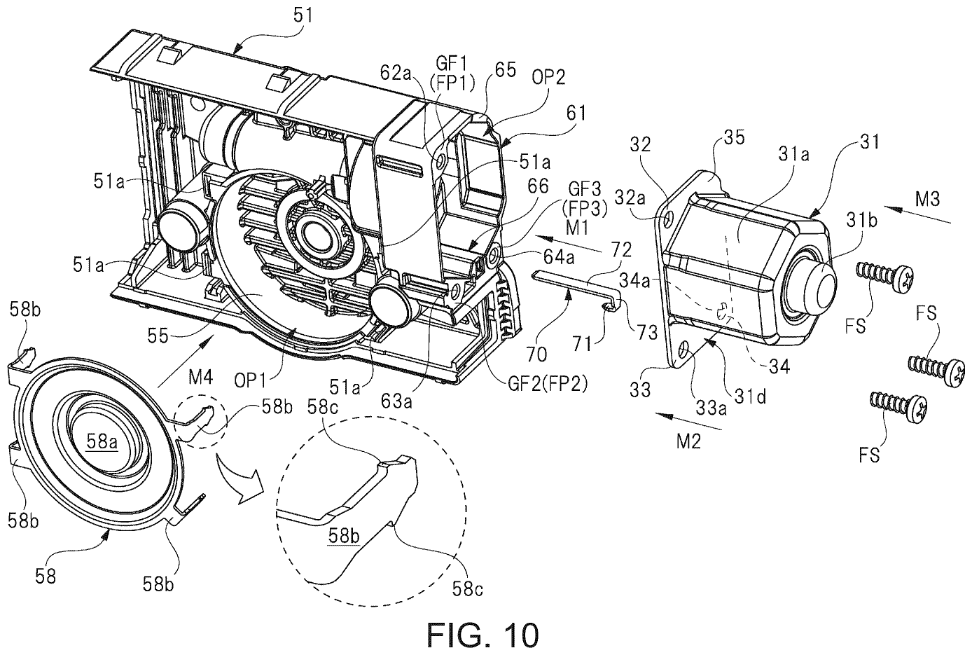

Herein, the worm wheel accommodating part 55 is opened on a side (close side in FIG. 4) opposite to the side where the first wall part 52 is provided in the axial direction of the output shaft 57. The opening portion of the worm wheel accommodating part 55 is closed by a cover member 58 formed in a substantially disc shape by subjecting a steel plate to pressing or the like, as shown in FIG. 3. That is, the cover member 58 closes a first opening OP1 (see FIG. 6 and FIG. 10) provided at the gear case 51.

The first opening OP1 corresponds to an opening in the present invention.

In addition, as shown in FIG. 4, a worm accommodating part 59 is provided on the inner side of the gear case 51. The worm accommodating part 59 is disposed in the vicinity of the second wall part 53. The worm accommodating part 59 is arranged alongside the worm wheel accommodating part 55 in a direction orthogonal to the axial direction of the rotating shaft 39, and the inside of the worm accommodating part 59 and the inside of the worm wheel accommodating part 55 communicate with each other. Accordingly, the worm 40 and the tooth part 56a are capable of meshing with each other.

The worm accommodating part 59 extends in the axial direction of the rotating shaft 39, and the second radial bearing B2 which rotatably supports the axial tip side of the rotating shaft 39 is accommodated on the other axial side (left side in FIG. 4) of the worm accommodating part 59.

Furthermore, a conductor support part 59a is provided between the worm accommodating part 59 and the second wall part 53. The conductor support part 59a supports, without rattling, the other longitudinal side (left side in FIG. 4) of the three conductors 44 held by the holder member 43. Accordingly, the motor board MB is capable of being easily connected to each of the conductors 44.

In addition, a bearing mounting part 60 is provided on the inner side of the gear case 51. The bearing mounting part 60 is disposed on the one axial side (right side in FIG. 4) of the worm accommodating part 59 and is opened toward the motor case 31. The ball bearing 41 is accommodated inside the bearing mounting part 60.

In this manner, the rotating shaft 39 is supported at three points by the first radial bearing B1, the second radial bearing B2, and the ball bearing 41. Accordingly, during operation of the sunroof motor 20, the worm 40 does not separate from the tooth part 56a of the worm wheel 56 (disengagement from each other does not occur), and power is capable of being reliably transmitted to each other.

Herein, the inner race 41a is fixed to the rotating shaft 39, and the outer race 41b is clamped by the bearing mounting part 60 and the holder member 43. Thus, the rotating shaft 39 does not move in the axial direction. Accordingly, it is not required to provide thrust bearings on both axial sides of the rotating shaft 39, and reduction in the number of parts is achieved.

### [Motor Accommodating Part]

As shown in FIG. 4 and FIG. 6 to FIG. 8, the gear case 51 is integrally provided with a motor accommodating part 61 formed in a substantially box shape. The motor accommodating part 61 is disposed on a side (right side in FIG. 4) where the motor case 31 is provided in the axial direction of the rotating shaft 39. The motor accommodating part 61 has a second opening OP2 on a side where the motor case 31 is provided, and a part of the electric motor part 30 is accommodated in the motor accommodating part 61. Specifically, as shown in FIG. 4, the wall part 43b of the holder member 43 forming the electric motor part 30 enters the motor accommodating part 61.

In addition, as shown in FIG. 6 and FIG. 7, the motor accommodating part 61 is formed in a substantially rectangular shape when viewed from the axial direction of the rotating shaft 39. At four corner parts of the motor accommodating part 61 on a side where the motor case 31 is provided, a first gear case-side corner part 62, a second gear case-side corner part 63, a third gear case-side corner part 64, and a gear case-side abutting part 65 are respectively provided.

The first gear case-side corner part 62 has a first gear case-side abutting surface GF1 (see a hatched part in FIG. 6 and FIG. 7) on a side (motor case 31 side) opposite to the worm accommodating part 59 side in the axial direction of the motor accommodating part 61. The first gear case-side abutting surface GF1 is a portion that is abutted against the first motor case-side abutting surface MF1 (see FIG. 5) of the motor case 31 in the axial direction of the rotating shaft 39. The first gear case-side corner part 62 is provided with a first female screw part 62a to which the fixing screw FS is screwed.

The second gear case-side corner part 63 has a second gear case-side abutting surface GF2 (see a hatched part in FIG. 6 and FIG. 7) on the side (motor case 31 side) opposite to the worm accommodating part 59 side in the axial direction of the motor accommodating part 61. The second gear case-side abutting surface GF2 is a portion that is abutted against the second motor case-side abutting surface MF2 (see FIG. 5) of the motor case 31 in the axial direction of the rotating shaft 39. The second gear case-side corner part 63 is provided with a second female screw part 63a to which the fixing screw FS is screwed.

The third gear case-side corner part 64 has a third gear case-side abutting surface GF3 (see a hatched part in FIG. 6 and FIG. 7) on the side (motor case 31 side) opposite to the worm accommodating part 59 side in the axial direction of the motor accommodating part 61. The third gear case-side abutting surface GF3 is a portion that is abutted against the third motor case-side abutting surface MF3 (see FIG. 5) of the motor case 31 in the axial direction of the rotating shaft 39. The third gear case-side corner part 64 is provided with a third female screw part 64a to which the fixing screw FS is screwed.

The total of three gear case-side abutting surfaces, i.e., the first, second, and third gear case-side abutting surfaces GF1, GF2, and GF3, provided at the motor accommodating part 61 of the gear case 51 are provided between the motor case 31 and the gear case 51, and respectively correspond to an abutting surface in the present invention.

In addition, the gear case-side abutting part 65 is a portion that is abutted against the motor case-side abutting part 35 (see FIG. 5) of the motor case 31 in the axial direction of the rotating shaft 39. The gear case-side abutting part 65 is disposed at a position opposed to the second gear case-side corner part 63 with the second opening OP2 as the center.

Herein, the first, second, and third gear case-side corner parts 62, 63, and 64 and the gear case-side abutting part 65 are disposed with high accuracy at the same positions as each other with respect to the axial direction of the rotating shaft 39 with a mold (not shown) used during molding of the gear case 51. In addition, the first, second, and third gear case-side corner parts 62, 63, and 64 and the gear case-side abutting part 65 expand with high accuracy without distortion in a direction orthogonal to the axial direction (left-right direction in FIG. 4) of the motor accommodating part 61. Thus, the first, second, and third gear case-side corner parts 62, 63, and 64 and the gear case-side abutting part 65 are abutted against the motor case 31 without rattling. Accordingly, the gear case 51 and the motor case 31 can be disposed straight and coaxially with each other.

Furthermore, the first, second, and third gear case-side corner parts 62, 63, and 64 and the gear case-side abutting part 65 protrude by a height dimension T1 (see FIG. 8) from an edge part E provided on the second opening OP2 side of the motor accommodating part 61. Specifically, the first, second, and third gear case-side corner parts 62, 63, and 64 and the gear case-side abutting part 65 protrude by the height dimension T1 from the edge part E to the one axial side (upper side in FIG. 8) of the rotating shaft 39.

Accordingly, an area (contact area) of an abutting portion (see the hatched parts in FIG. 5 to FIG. 7) between the gear case 51 and the motor case 31 can be reduced to enable the gear case 51 and the motor case 31 to be easily abutted with each other without rattling. Thus, the gear case 51 and the motor case 31 can be disposed with high accuracy to be straight and coaxial.

Herein, the first gear case-side abutting surface GF1 and the first motor case-side abutting surface MF1 are abutted against each other to form a pair, and form a first fixing part FP1. In addition, the second gear case-side abutting surface GF2 and the second motor case-side abutting surface MF2 are abutted against each other to form a pair, and form a second fixing part FP2. Furthermore, the third gear case-side abutting surface GF3 and the third motor case-side abutting surface MF3 are abutted against each other to form a pair, and form a third fixing part FP3.

The total of three fixing parts, i.e., the first, second, and third fixing parts FP1, FP2, and FP3, each correspond to a fixing part in the present invention.

As shown in FIG. 7, a first gear case-side line segment GL1, which connects the first gear case-side abutting surface GF1 having the first female screw part 62a disposed at the center and the second gear case-side abutting surface GF2 having the second female screw part 63a disposed at the center, extends in the width direction (up-down direction in FIG. 4) of the sunroof motor 20.

In addition, a second gear case-side line segment GL2, which connects the second gear case-side abutting surface GF2 having the second female screw part 63a disposed at the center and the third gear case-side abutting surface GF3 having the third female screw part 64a disposed at the center, extends in the thickness direction (depth direction in FIG. 4) of the sunroof motor 20.

Furthermore, a third gear case-side line segment GL3, which connects the first gear case-side abutting surface GF1 having the first female screw part 62a disposed at the center and the third gear case-side abutting surface GF3 having the third female screw part 64a disposed at the center, extends to cross a substantially axial center part of the motor accommodating part 61, i.e., a substantially central part of the second opening OP2.

In this manner, the first, second, and third gear case-side abutting surfaces GF1, GF2, and GF3 and the gear case-side abutting part 65 are disposed around the rotating shaft 39 with the second opening OP2 as the center.

The first, second, and third gear case-side line segments GL1, GL2, and GL3 form an isosceles triangle, and the size relationship of length dimensions L1, L2, and L3 of the first, second, and third gear case-side line segments GL1, GL2, and GL3 is L3>L1>L2.

In the assembled state of the sunroof motor 20, a clamped part 73 (see FIG. 9) of the ground terminal 70 is disposed between the second gear case-side corner part 63 and the third gear case-side corner part 64 of the motor accommodating part 61. That is, the ground terminal 70 is disposed only between the second gear case-side abutting surface GF2 and the third gear case-side abutting surface GF3 forming the second gear case-side line segment GL2, which is shortest among the first, second, and third gear case-side line segments GL1, GL2, and GL3 connecting the first, second, and third gear case-side abutting surfaces GF1, GF2, and GF3 adjacent to each other in the circumferential direction of the rotating shaft 39.

The ground terminal 70 has a rod shape extending in the axial direction of the rotating shaft 39, and is disposed only between the second gear case-side abutting surface GF2 and the third gear case-side abutting surface GF3. In addition, the first, second, and third gear case-side line segments GL1, GL2, and GL3 each correspond to a line segment in the present invention.

### [Terminal Mounting Part]

As shown in FIG. 6 to FIG. 8, the motor accommodating part 61 is provided with a terminal mounting part 66. Specifically, the terminal mounting part 66 is disposed between the second gear case-side corner part 63 and the third gear case-side corner part 64 when viewing the motor accommodating part 61 from the axial direction of the rotating shaft 39. That is, the terminal mounting part 66 is disposed on the second gear case-side line segment GL2 when viewing the motor accommodating part 61 from the axial direction of the rotating shaft 39.

The terminal mounting part 66 has a function of supporting the ground terminal 70. As shown in FIG. 6, the terminal mounting part 66 includes a first terminal insertion hole 66a, a second terminal insertion hole 66b, and a terminal abutting part 67. The first and second terminal insertion holes 66a and 66b both have a substantially rectangular cross-section in a direction orthogonal to the axial direction of the rotating shaft 39.

In addition, as shown in FIG. 7, the first terminal insertion hole 66a is disposed on a side (lower side in FIG. 7) opposite to the second opening OP2 side of the motor accommodating part 61 when viewing the rotating shaft 39 from the axial direction. On the other hand, the second terminal insertion hole 66b is disposed on the second opening OP2 side (upper side in FIG. 7) of the motor accommodating part 61 when viewing the rotating shaft 39 from the axial direction. In this manner, the first and second terminal insertion holes 66a and 66b are respectively disposed at different positions in a direction orthogonal to the axial direction of the rotating shaft 39.

Furthermore, as shown in FIG. 6, in the axial direction of the rotating shaft 39, the first terminal insertion hole 66a is disposed on the second opening OP2 side of the motor accommodating part 61, and the second terminal insertion hole 66b is disposed on the bearing mounting part 60 side of the motor accommodating part 61. In this manner, the first and second terminal insertion holes 66a and 66b are respectively disposed at different positions in the axial direction of the rotating shaft 39. That is, the first terminal insertion hole 66a is disposed on the outer side of the gear case 51 in the axial direction of the rotating shaft 39, and the second terminal insertion hole 66b is disposed on the inner side of the gear case 51 in the axial direction of the rotating shaft 39.

Accordingly, a short part 71 (see FIG. 9) of the ground terminal 70 is capable of being inserted into the first terminal insertion hole 66a, and a long part 72 (see FIG. 9) of the ground terminal 70 is capable of being inserted into the second terminal insertion hole 66b.

In addition, as shown in FIG. 6 and FIG. 7, the terminal abutting part 67 is disposed between the first terminal insertion hole 66a and the second terminal insertion hole 66b in a direction orthogonal to the axial direction of the rotating shaft 39. As shown in FIG. 6 and FIG. 8, the terminal abutting part 67 includes a pair of insertion guides 67a and a pair of triangular protrusions 67b.

The pair of insertion guides 67a have a function of guiding mounting of the ground terminal 70 to the terminal mounting part 66, i.e., guiding an insertion action of the ground terminal 70 into the first and second terminal insertion holes 66a and 66b. On the other hand, as shown in FIG. 8, a tip side (upper side in FIG. 8) of the pair of triangular protrusions 67b has a tapered shape, and becomes a portion that is crushed by the clamped part 73 (see FIG. 9) of the ground terminal 70 when abutting and fixing the gear case 51 and the motor case 31 with each other.

Since the pair of triangular protrusions 67b are made of resin, the pair of triangular protrusions 67b have some elasticity. Thus, the pair of triangular protrusions 67b have a function of pushing back the clamped part 73 of the ground terminal 70 toward the motor case 31.

Herein, the pair of triangular protrusions 67b provided at the gear case 51 correspond to a protrusion in the present invention.

As shown in FIG. 8, in the axial direction (up-down direction in FIG. 8) of the rotating shaft 39, with the position of the edge part E of the motor accommodating part 61 as a reference, when the height dimension of the first, second, and third gear case-side corner parts 62, 63, and 64 and the gear case-side abutting part 65 is T1, the depth dimension to the top of the insertion guide 67a is D1, the depth dimension to the top of the triangular protrusion 67b is D2, and the thickness dimension of the ground terminal 70 (clamped part 73) is T2, Formula (1) below holds.

$$( D 2 + T 1 ) < T 2 < ( D 1 + T 1 ) \qquad Formula ( 1 )$$

That is, in a state in which a lower surface BS of the clamped part 73 is placed on the pair of triangular protrusions 67b and the pair of triangular protrusions 67b are not crushed respectively, an upper surface US1 of the clamped part 73 is in a state of protruding to the one axial side (upper side in FIG. 8) of the rotating shaft 39 beyond the first, second, and third gear case-side abutting surfaces GF1, GF2, and GF3 and an upper surface US2 of the gear case-side abutting part 65. Such a state in which the upper surface US1 protrudes to the one axial side of the rotating shaft 39 beyond the first, second, and third gear case-side abutting surfaces GF1, GF2, and GF3 and the upper surface US2 (see FIG. 7) is referred to as a “clamped part placement state”.

In the “clamped part placement state”, upon abutting the motor case 31 against the gear case 51 and tightening the total of three fixing screws FS (see FIG. 10) with a specified tightening torque, the clamped part 73 is pressed by the pressing part 36 (see FIG. 5) of the motor case 31. Accordingly, the tip side of the pair of triangular protrusions 67b is crushed to the other axial side (lower side in FIG. 8) of the rotating shaft 39. Thus, the upper surface US1 of the clamped part 73, and the first, second, and third gear case-side abutting surfaces GF1, GF2, and GF3 and the upper surface US2 (see FIG. 7) are respectively in a “flush state”.

Herein, in the “flush state”, the lower surface BS of the clamped part 73 and the top of the pair of insertion guides 67a are in a non-contact state with each other. That is, when a crushing allowance of the pair of triangular protrusions 67b is Δt, Formula (2) below is satisfied.

$$Δ t = ( D 1 + T 1 ) - T 2 \qquad Formula ( 2 )$$

Since the thickness dimension T2 of the clamped part 73 is smaller than a value obtained by adding the depth dimension D1 to the top of the insertion guide 67a and the height dimension T1 of the first, second, and third gear case-side corner parts 62, 63, and 64 and the gear case-side abutting part 65 (see Formula (1) above), the clamped part 73 only needs to crush a part of the tip side of the pair of triangular protrusions 67b.

Accordingly, the ground terminal 70 is fixed to the terminal mounting part 66 at a specified position without rattling. In addition, an excessive tightening torque of the total of three fixing screws FS is suppressed, and damage to the first, second, and third female screw parts 62a, 63a, and 64a (made of resin) is suppressed. Furthermore, the clamped part 73 of the ground terminal 70 is pushed back toward the pressing part 36 by the pair of triangular protrusions 67b, and is reliably electrically connected to the motor case 31.

### [Ground Terminal]

The ground terminal 70 mounted to the terminal mounting part 66 is formed in a substantially J-shape by punching a brass plate or the like having excellent conductivity into a rod shape and bending it, as shown in FIG. 9. Specifically, the ground terminal 70 includes a short part 71, a long part 72, and a clamped part 73.

A width dimension of the short part 71 is smaller than a width dimension of the long part 72, and a length dimension of the short part 71 is approximately ⅕ the size of a length dimension of the long part 72. In addition, the clamped part 73 is a portion that is clamped by the motor case 31 and the gear case 51, and includes a lower surface BS and an upper surface US1.

By forming the ground terminal 70 in a substantially J-shape in this manner, the short part 71 is capable of being inserted into the first terminal insertion hole 66a, and the long part 72 is capable of being inserted into the second terminal insertion hole 66b.

The short part 71 includes a short body 71a, and the clamped part 73 is integrally provided at a base part of the short body 71a. The short body 71a and the clamped part 73 are bent to be perpendicular (90 degrees) to each other.

In addition, a short-side tapered part 71b that gradually becomes a tapered shape toward the tip side is provided at a tip part of the short body 71a. Herein, the short-side tapered part 71b has a function of guiding an insertion action of the short part 71 into the first terminal insertion hole 66a.

Furthermore, hooking claws 71c are respectively provided on both sides in the width direction of the short body 71a. Herein, the pair of hooking claws 71c are portions that are hooked inside the first terminal insertion hole 66a when the short part 71 is inserted into the first terminal insertion hole 66a. Accordingly, the ground terminal 70 is capable of being temporarily fixed to the terminal mounting part 66. That is, the ground terminal 70 is prevented from falling off from the terminal mounting part 66 when fixing the motor case 31 to the gear case 51.

The pair of hooking claws 71c hooked to the gear case 51 correspond to a claw part in the present invention.

The long part 72 includes along body 72a, and the clamped part 73 is integrally provided at a base part of the long body 72a. The long body 72a and the clamped part 73 are bent to be perpendicular (90 degrees) to each other. Accordingly, the short part 71 and the long part 72 are parallel to each other with the clamped part 73 interposed therebetween.

In addition, a long-side tapered part 72b that gradually becomes a tapered shape toward the tip side is provided at a tip part of the long body 72a. Herein, the long-side tapered part 72b has a function of guiding an insertion action of the long part 72 into the second terminal insertion hole 66b. The tip side of the long part 72 is electrically connected to a fixing leg part 58b (see FIG. 4 and FIG. 10) of the cover member 58.

The long part 72 extends straight in the axial direction of the rotating shaft 39, the tip side thereof is disposed inside the gear case 51, and corresponds to a body part in the present invention.

The clamped part 73 extends in a direction intersecting with the axial direction of the rotating shaft 39, specifically, in a direction perpendicular to the axial direction of the rotating shaft 39, and as shown in FIG. 8, the lower surface BS of the clamped part 73 is abutted against the terminal abutting part 67 from the one axial side (upper side in FIG. 8) of the rotating shaft 39. On the other hand, the upper surface US1 of the clamped part 73 is pressed by the pressing part 36 (see FIG. 5) from the one axial side of the rotating shaft 39 and is electrically connected to the motor case 31.

In this manner, the ground terminal 70 made of metal has a function of electrically connecting the motor case 31 made of metal and the cover member 58 made of metal to each other in an assembled state of the sunroof motor 20. That is, electrical noise generated during rotation of the rotating shaft 39 flows through the ground terminal 70.

The ground terminal 70 corresponds to a conductive member in the present invention.

### [Cover Member]

As shown in FIG. 3, the cover member 58 includes a cover body 58a formed in a substantially disc shape. The cover body 58a closes an opening portion (first opening OP1 of the gear case 51) of the worm wheel accommodating part 55. In addition, a total of four fixing leg parts 58b are integrally provided at an outer circumferential part of the cover body 58a. These fixing leg parts 58b each extend in the axial direction of the output shaft 57 (see FIG. 2) with respect to the cover body 58a. That is, the total of four fixing leg parts 58b are each bent to be perpendicular (90 degrees) with respect to the cover body 58a.

As shown in FIG. 10, a pair of cover claws 58c are provided on the tip side of the fixing leg part 58b, and these cover claws 58c are inserted into a total of four cover fixing holes 51a (see FIG. 4) provided at the gear case 51 and are in a state of being prevented from coming off from the cover fixing holes 51a. As shown in FIG. 4, the tip side of the long part 72 forming the ground terminal 70 is electrically connected to one fixing leg part 58b among the total of four fixing leg parts 58b, specifically, to the fixing leg part 58b disposed at the upper right in FIG. 4.

In this manner, the cover member 58 is electrically connected to both the motor board MB and the ground terminal 70, and accordingly, electrical noise generated during rotation of the rotating shaft 39 is released from the motor case 31 to the body of the vehicle 12 (see FIG. 1) via the ground terminal 70, the cover member 58, and the motor board MB.

The cover member 58 corresponds to a gear cover in the present invention.

### [Metal Jacket]

Herein, in the sunroof motor 20 of the present embodiment, other electrical noise countermeasures are also implemented to prevent electrical noise from being radiated to outside.

Specifically, as shown in FIG. 2 to FIG. 4, a metal jacket 80 made of metal and formed by bending a thin steel plate is partially mounted on the outer side of the gear case 51. The metal jacket 80 partially covers the periphery of the rotating shaft 39 and the conductors 44 through which electrical noise is easily transmitted. Accordingly, radiation of electrical noise from the rotating shaft 39 and the conductors 44 to outside of the sunroof motor 20 is suppressed.

### [Assembly Procedure of Sunroof Motor]

Next, an assembly procedure of the sunroof motor 20 formed as described above, particularly an assembly procedure of the ground terminal 70, the motor case 31, and the cover member 58 to the gear case 51, will be described in detail with reference to the drawings.

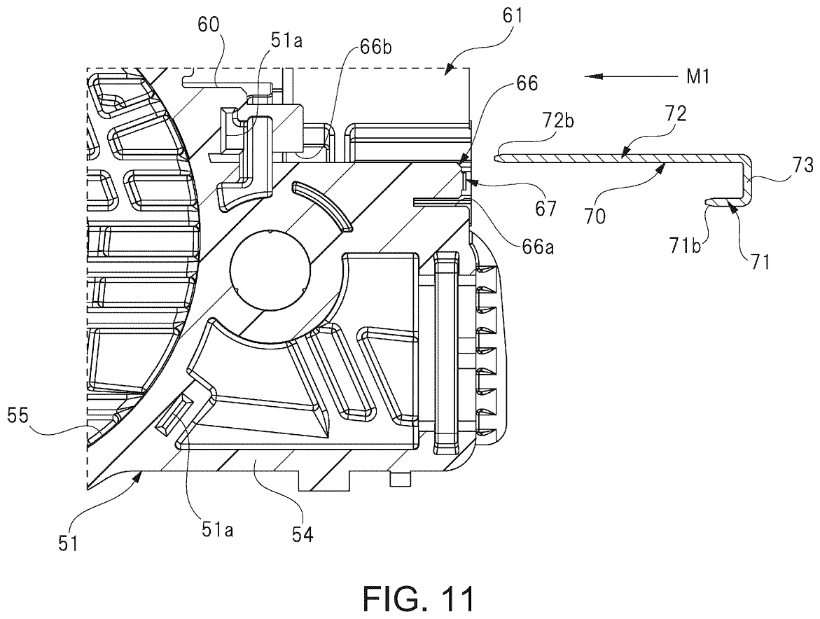

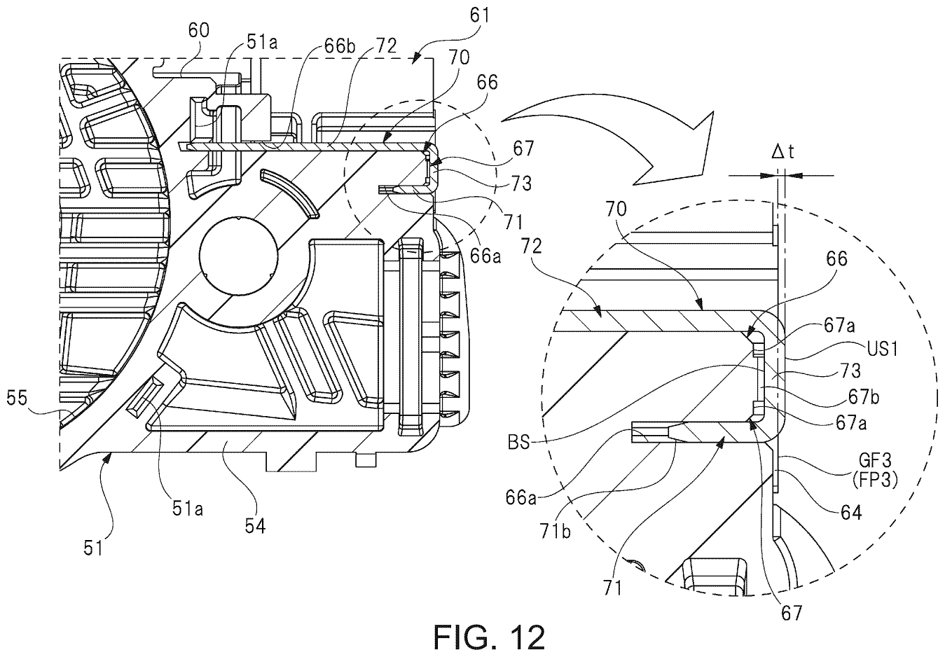

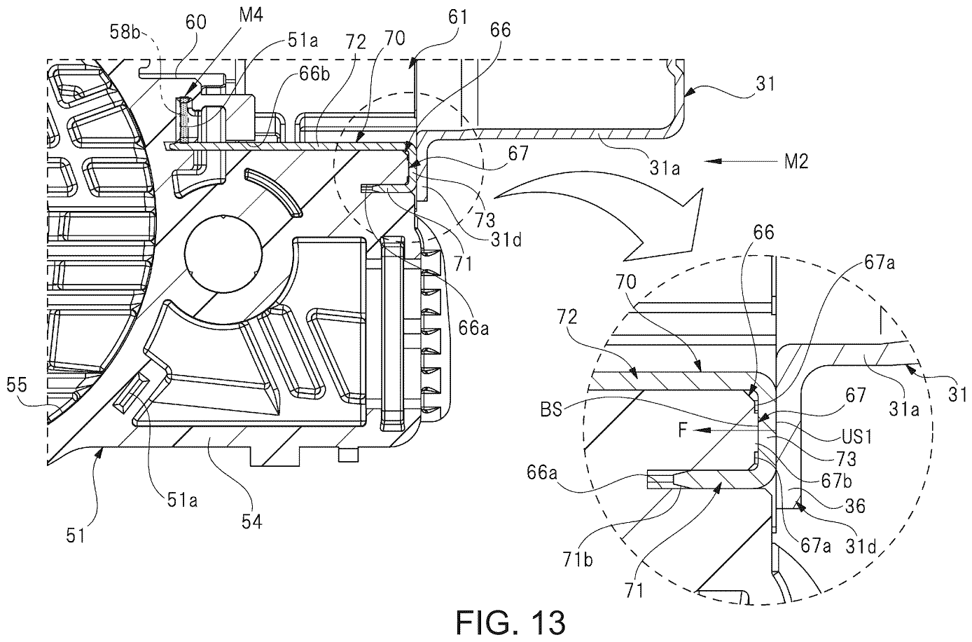

FIG. 10 shows an exploded perspective view of the sunroof motor (internal structure omitted). FIG. 11 shows a view illustrating an assembly procedure (1) of the sunroof motor. FIG. 12 shows a view illustrating an assembly procedure (2) of the sunroof motor. FIG. 13 shows a view illustrating an assembly procedure (3) of the sunroof motor.

First, as shown in FIG. 10, a gear case 51, a ground terminal 70, a motor case 31, a cover member 58, and a total of three fixing screws FS, each manufactured through separate manufacturing processes, are prepared. In FIG. 10 to FIG. 13, illustration of the stator 37, the rotor 38, the holder member 43, etc. accommodated inside the motor case 31, and the worm wheel 56 and the like accommodated inside the gear case 51 is omitted.

As indicated by an arrow M1 in FIG. 10 and FIG. 11, the ground terminal 70 is caused to face the terminal mounting part 66 of the gear case 51 from the one axial side (right side in the figure) of the rotating shaft 39. Specifically, the tip side of the short part 71 is caused to face the first terminal insertion hole 66a, and the tip side of the long part 72 is caused to face the second terminal insertion hole 66b.

Next, the tip part of the short part 71 is inserted into the first terminal insertion hole 66a, and the tip part of the long part 72 is inserted into the second terminal insertion hole 66b. At this time, the ground terminal 70 is guided to a specified position of the terminal mounting part 66 by the pair of insertion guides 67a. In addition, insertion actions of the short part 71 and the long part 72 into the first terminal insertion hole 66a and the second terminal insertion hole 66b are guided by the short-side tapered part 71b and the long-side tapered part 72b. Thus, the ground terminal 70 is capable of being easily mounted to the terminal mounting part 66.

Accordingly, as shown in FIG. 12, the lower surface BS of the clamped part 73 is supported by the tip parts of the pair of triangular protrusions 67b. At this time, the upper surface US1 of the clamped part 73 is in a state of protruding to the one axial side (right side in the figure) of the rotating shaft 39 beyond the first, second, and third gear case-side abutting surfaces GF1, GF2, and GF3 and the upper surface US2 of the gear case-side abutting part 65 (see FIG. 6 and FIG. 7), i.e., in the “clamped part placement state”. Accordingly, temporary fixing of the ground terminal 70 to the terminal mounting part 66 is completed.

In the “clamped part placement state”, the hooking claw 71c (see FIG. 9) of the short part 71 is hooked inside the first terminal insertion hole 66a. Thus, the ground terminal 70 does not fall off from the gear case 51, and improvement in assemblability is achieved.

Next, as indicated by an arrow M2 in FIG. 10 and FIG. 13, the motor case 31 is caused to face the motor accommodating part 61 of the gear case 51 from the one axial side (right side in the figure) of the rotating shaft 39. Specifically, in the axial direction of the rotating shaft 39, the first motor case-side abutting surface MF1 (see FIG. 5) is caused to be opposed to the first gear case-side abutting surface GF1 (see FIG. 6 and FIG. 7), the second motor case-side abutting surface MF2 (see FIG. 5) is caused to be opposed to the second gear case-side abutting surface GF2 (see FIG. 6 and FIG. 7), the third motor case-side abutting surface MF3 (see FIG. 5) is caused to be opposed to the third gear case-side abutting surface GF3 (see FIG. 6 and FIG. 7), and the motor case-side abutting part 35 (see FIG. 5) is caused to be opposed to the gear case-side abutting part 65 (see FIG. 6 and FIG. 7).

Accordingly, in the axial direction of the rotating shaft 39, the pressing part 36 of the flange part 31d is opposed to the clamped part 73 of the ground terminal 70.

Thereafter, as indicated by an arrow M3 in FIG. 10, a total of three fixing screws FS are inserted through the first, second, and third screw insertion holes 32a, 33a, and 34a and screwed to the first, second, and third female screw parts 62a, 63a, and 64a with a specified tightening torque. Accordingly, the paired first motor case-side abutting surface MF1 and first gear case-side abutting surface GF1 are abutted against each other, the paired second motor case-side abutting surface MF2 and second gear case-side abutting surface GF2 are abutted against each other, the paired third motor case-side abutting surface MF3 and third gear case-side abutting surface GF3 are abutted against each other, and the motor case-side abutting part 35 and the gear case-side abutting part 65 are abutted against each other.

Thus, the motor case 31 is disposed straight and coaxially with respect to the gear case 51 without rattling. At this time, by tightening each fixing screw FS with a specified tightening torque, as shown in FIG. 13, the upper surface US1 of the clamped part 73 is pressed by the pressing part 36 with a pressing force F from the one axial side (right side in the figure) of the rotating shaft 39. Thus, the tip side of the pair of triangular protrusions 67b is crushed by the lower surface BS of the clamped part 73 by the amount of a crush allowance Δt (see FIG. 12). Accordingly, the assembly work of the motor case 31 and the gear case 51 is completed.

Herein, the specified tightening torque of the fixing screws FS that generates the pressing force F is a tightening torque of a magnitude capable of crushing the tip side of the pair of triangular protrusions 67b by the lower surface BS of the clamped part 73 by the amount of the crush allowance Δt, without damaging the resin-made first, second, third female screw parts 62a, 63a, and 64a.

Herein, in the present embodiment, the motor case 31 and the gear case 51 are fixed to each other with a total of three fixing screws FS. This is because, for example, upon fixing the motor case 31 and the gear case 51 with a total of two fixing screws, the motor case 31 and the gear case 51 may incline with respect to each other around a line segment connecting the two fixing screws, which may hinder smooth rotation of the rotating shaft 39. On the other hand, for example, upon fixing the motor case 31 and the gear case 51 with a total of four fixing screws, in the relatively compact sunroof motor 20, the fixing strength becomes excessive and causes an increase in assembly man-hours.

Next, as indicated by an arrow M4 in FIG. 10, the cover member 58 is caused to face the opening side of the worm wheel accommodating part 55, i.e., the first opening OP1 of the gear case 51. At this time, the tip side of the fixing leg parts 58b is directed toward the cover fixing holes 51a of the gear case 51. Then, the respective fixing leg parts 58b are inserted into the respective cover fixing hole 51a. Thus, the cover claws 58c are in a state of being retained against the cover fixing holes 51a, and the mounting of the cover member 58 to the gear case 51 is completed.

Accordingly, as shown in FIG. 4, the tip side of the long part 72 of the ground terminal 70 is electrically connected to the upper-right fixing leg part 58b in the figure among the total of four fixing leg parts 58b.

As described in detail above, according to the present embodiment, the ground terminal 70 is provided to be clamped between the motor case 31 and the gear case 51, and electrical noise generated due to rotation of the rotating shaft 39 flows through the ground terminal 70. The first to third fixing parts FP1 to FP3, which are disposed around the rotating shaft 39 and are composed of the first to third motor case-side abutting surfaces MF1 to MF3 and the first to third gear case-side abutting surfaces GF1 to GF3 abutted against each other, are provided between the motor case 31 and the gear case 51.

The ground terminal 70 is disposed only between the second fixing part FP2 and the third fixing part FP3, which form the shortest line segment (second motor case-side line segment ML2 and second gear case-side line segment GL2) among the line segments (first to third motor case-side line segments ML1 to ML3 and first to third gear case-side line segments GL1 to GL3) connecting the first to third fixing parts FP1 to FP3 adjacent to each other in the circumferential direction of the rotating shaft 39.

Accordingly, when fixing the motor case 31 to the gear case 51 using the fixing screws FS, the ground terminal 70 can be pressed toward the terminal mounting part 66 of the gear case 51 without deforming the flange part 31d (pressing part 36) of the motor case 31, while abutting the motor case 31 and the gear case 51 straight and coaxially against each other. Thus, it becomes possible to reduce operating noise while improving the assemblability of the sunroof motor 20.

In addition, according to the present embodiment, the ground terminal 70 includes the long part 72 which extends in the axial direction of the rotating shaft 39 and is disposed inside the gear case 51, and the clamped part 73 which extends in a direction intersecting with the axial direction of the rotating shaft 39 and is clamped by the motor case 31 and the gear case 51.

Accordingly, electrical noise transmitted to the motor case 31 can be transmitted from the motor case 31 side to the gear case 51 side (the side where the motor board MB is provided) in the axial direction of the rotating shaft 39 via the ground terminal 70.

Furthermore, according to the present embodiment, the long part 72 is electrically connected to the cover member 58 made of metal which closes the first opening OP1 provided at the gear case 51 made of resin.

Accordingly, electrical noise generated due to rotation of the rotating shaft 39 can be transmitted from the motor case 31 to the cover member 58 made of metal via the ground terminal 70.

In addition, according to the present embodiment, the gear case 51 has the pair of triangular protrusions 67b which are crushed by the clamped part 73.

Accordingly, the clamped part 73 of the ground terminal 70 is pushed back toward the pressing part 36 of the motor case 31 by the pair of triangular protrusions 67b, and thus the ground terminal 70 can be reliably electrically connected to the motor case 31.

Furthermore, according to the present embodiment, the ground terminal 70 includes the pair of hooking claws 71c which are hooked to the gear case 51.

Accordingly, the ground terminal 70 can be temporarily fixed to the terminal mounting part 66. Thus, when fixing the motor case 31 and the gear case 51 to each other, fall-off of the ground terminal 70 from the terminal mounting part 66 can be prevented, and thus the assemblability of the sunroof motor 20 can be further improved.

In addition, according to the present embodiment, since the motor case 31 and the gear case 51 can be assembled to each other with high accuracy, waste such as generation of defective products and reassembly can be eliminated to achieve energy saving in manufacturing. Accordingly, among the Sustainable Development Goals (SDGs) established by the United Nations, particularly Goal 7 (ensure access to affordable, reliable, sustainable and modern energy for all) and Goal 13 (take urgent action to combat climate change and its impacts) can be realized.

### Embodiment 2

Next, Embodiment 2 of the present invention will be described in detail with reference to the drawings. Portions having the same functions as Embodiment 1 will be labeled with the same reference signs, and detailed descriptions thereof will be omitted.

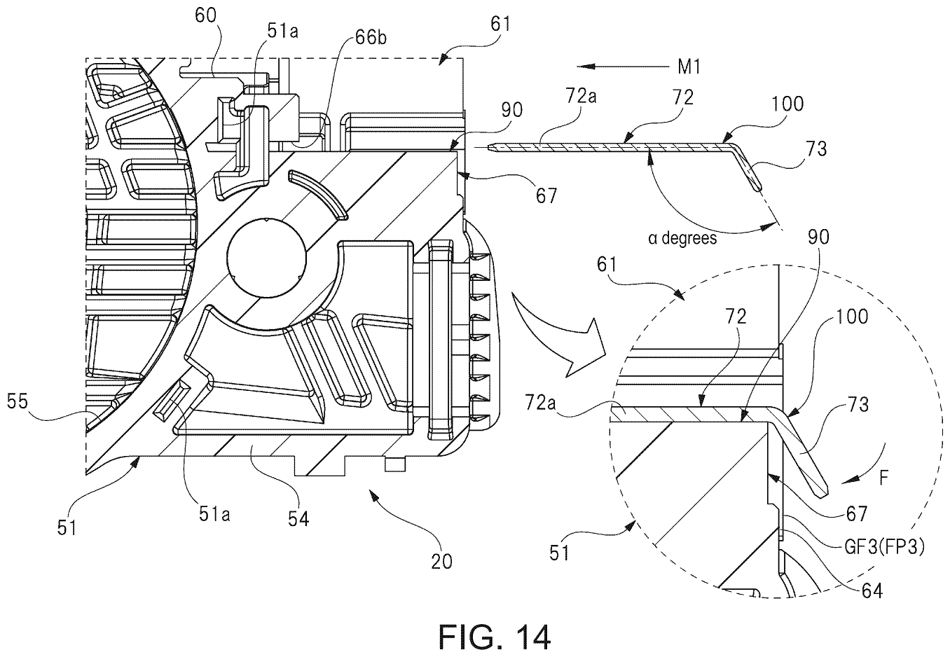

FIG. 14 is a view corresponding to FIG. 11 showing Embodiment 2.

As shown in FIG. 14, in a sunroof motor 20 of Embodiment 2, compared to Embodiment 1 (see FIG. 11), the shape of a terminal mounting part 90 of the motor accommodating part 61 and the shape of a ground terminal (conductive member) 100 mounted to the terminal mounting part 90 are different.

Specifically, compared to the terminal mounting part 66 (see FIG. 11) of Embodiment 1, the terminal mounting part 90 of Embodiment 2 includes the second terminal insertion hole 66b but does not include the first terminal insertion hole 66a. In addition, the terminal abutting part 67 of Embodiment 2 is a simple flat surface expanding in a direction orthogonal to the axial direction of the rotating shaft 39, and does not include the pair of insertion guides 67a and the pair of triangular protrusions 67b (see FIG. 11).

That is, the terminal mounting part 90 of Embodiment 2 has a simplified structure compared to the terminal mounting part 66 of Embodiment 1.

In addition, compared to the ground terminal 70 (see FIG. 9) of Embodiment 1, the ground terminal 100 of Embodiment 2 includes the long part 72 but does not include the short part 71. That is, the ground terminal 100 of Embodiment 2 has a simplified structure compared to the ground terminal 70 of Embodiment 1.

Furthermore, the clamped part 73 integrally provided at the base of the long body 72a is bent to be a degrees (approximately 120 degrees) with respect to the long body 72a. That is, the clamped part 73 forming the ground terminal 100 of Embodiment 2 is inclined with respect to both the axial direction of the rotating shaft 39 and the direction orthogonal to the axial direction of the rotating shaft 39.

Accordingly, by abutting the motor case 31 (see FIG. 5) against the gear case 51 and tightening the fixing screws FS (see FIG. 3) with a specified tightening torque, the clamped part 73 is pressed by the pressing part 36 (see FIG. 5) with a pressing force F. Thus, the clamped part 73 is elastically contacted to push back against the motor case 31 (pressing part 36), and the ground terminal 100 and the motor case 31 are reliably electrically contacted.

Herein, as shown by a dashed-line circle in FIG. 14, in a state in which the ground terminal 100 is mounted to the terminal mounting part 90 and the motor case 31 is not abutted against the gear case 51, the tip side (lower right side in the figure) of the clamped part 73 is in a state of protruding to the one axial side (right side in FIG. 14) of the rotating shaft 39 beyond the first, second, and third gear case-side abutting surfaces GF1, GF2, and GF3 and the upper surface US2 (see FIG. 7) of the gear case-side abutting part 65.

In Embodiment 2 formed as described above, substantially the same effects as Embodiment 1 can be achieved, except for the temporary fixing function of the short part 71 to the first terminal insertion hole 66a (see FIG. 12) in Embodiment 1. In addition, in Embodiment 2, since the structure of the terminal mounting part 90 and the structure of the ground terminal 100 can be simplified, it becomes possible to reduce manufacturing costs.

The present invention is not limited to the above embodiments, and obviously various modifications may be made without departing from the gist thereof. For example, although Embodiment 1 described above has shown that the terminal abutting part 67 of the terminal mounting part 66 is provided with a pair of insertion guides 67a (see FIG. 6), the present invention is not limited thereto, and the pair of insertion guides 67a may also be omitted. In addition, it is also possible that only one of the pair of triangular protrusions 67b is provided, or the shape thereof may be formed to protrude upward in an arc shape. In short, as long as the strength of the protrusion is a strength that is crushed by the pressing force F (see FIG. 13), the number and shape of the protrusions may be any number and shape.

In addition, although each of the above embodiments has shown that the present invention is applied to the sunroof motor 20 used in the sunroof device 10 of the vehicle 12, the present invention is not limited thereto and may also be applied to vehicle-mounted motor devices used in, for example, sliding door devices, power window devices, wiper devices, etc. mounted on vehicles.

In addition, the material, shape, dimensions, number, installation spots, etc. of each component in each of the above embodiments may be configured in any manner as long as the present invention can be achieved, and are not limited to each of the above embodiments.

### REFERENCE SIGNS LIST

10: sunroof device, 11: roof panel, 12: vehicle, 13: roof, 14: roof opening, 15a, 15b: shoe, 16: guide rail, 17a, 17b: drive cable, 20: sunroof motor (motor device), 30: electric motor part, 31: motor case, 31a: sidewall part, 31b: bottom wall part, 31c: motor case-side opening, 31d: flange part, 32: first motor case-side corner part, 32a: first screw insertion hole, 33: second motor case-side corner part, 33a: second screw insertion hole, 34: third motor case-side corner part, 34a: third screw insertion hole, 35: motor case-side abutting part, 36: pressing part, 37: stator, 37a: stator core, 37b: teeth, 37c: insulator, 38: rotor, 38a: rotor core, 38b: magnet holder, 39: rotating shaft, 40: worm (gear), 41: ball bearing, 41a: inner race, 41b: outer race, 41c: ball, 42: sensor magnet unit, 42a: bracket member, 42b: sensor magnet, 43: holder member, 43a: support body, 43b: wall part, 43c: annular support part, 44: conductor, 50: reduction mechanism part, 51: gear case, 51a: cover fixing hole, 52: first wall part, 53: second wall part, 54: third wall part, 55: worm wheel accommodating part, 56: worm wheel (gear), 56a: tooth part, 57: output shaft, 57a: output gear, 58: cover member (gear cover), 58a: cover body, 58b: fixing leg part, 58c: cover claw, 59: worm accommodating part, 59a: conductor support part, 60: bearing mounting part, 61: motor accommodating part, 62: first gear case-side corner part, 62a: first female screw part, 63: second gear case-side corner part, 63a: second female screw part, 64: third gear case-side corner part, 64a: third female screw part, 65: gear case-side abutting part, 66: terminal mounting part, 66a: first terminal insertion hole, 66b: second terminal insertion hole, 67: terminal abutting part, 67a: insertion guide, 67b: triangular protrusion (protrusion), 70: ground terminal (conductive member), 71: short part, 71a: short body, 71b: short-side tapered part, 71c: hooking claw (claw part), 72: long part (body part), 72a: long body, 72b: long-side tapered part, 73: clamped part, 80: metal jacket, 90: terminal mounting part, 100: ground terminal (conductive member), AG: air gap, B1: first radial bearing, B2: second radial bearing, BS: lower surface, CL: coil, D1: depth dimension to top of insertion guide 67a, D2: depth dimension to top of triangular protrusion 67b, E: edge part, F: pressing force, FG: windshield, FP1: first fixing part (fixing part), FP2: second fixing part (fixing part), FP3: third fixing part (fixing part), FS: fixing screw, GF1: first gear case-side abutting surface (abutting surface), GF2: second gear case-side abutting surface (abutting surface), GF3: third gear case-side abutting surface (abutting surface), GL1: first gear case-side line segment (line segment), GL2: second gear case-side line segment (line segment), GL3: third gear case-side line segment (line segment), L1, L2, L3: length dimensions of first, second, and third gear case-side line segments, MB: motor board, MF1: first motor case-side abutting surface (abutting surface), M1, M2, M3, M4: arrow, MF2: second motor case-side abutting surface (abutting surface), MF3: third motor case-side abutting surface (abutting surface), MG: magnet, ML1: first motor case-side line segment (line segment), ML2: second motor case-side line segment (line segment), ML3: third motor case-side line segment (line segment), OP1: first opening (opening), OP2: second opening, SD: reduction mechanism, T1: height dimension of gear case-side abutting part 65, T2: thickness dimension of ground terminal 70 (clamped part 73), US1, US2: upper surface, Δt: crushing allowance

1. A motor device comprising:
a rotating shaft; and
a gear rotated by the rotating shaft,
the motor device comprising:
a motor case accommodating the rotating shaft;
a gear case accommodating the gear; and
a conductive member that is clamped between the motor case and the gear case and through which electrical noise generated due to rotation of the rotating shaft flows, wherein
at least three fixing parts disposed around the rotating shaft and each composed of a pair of abutting surfaces abutted against each other are provided between the motor case and the gear case, and
the conductive member is disposed only between the fixing parts that form a shortest line segment among line segments connecting the fixing parts adjacent to each other in a circumferential direction of the rotating shaft.

2. The motor device as claimed in claim 1, wherein
the conductive member comprises:
a body part extending in an axial direction of the rotating shaft and disposed inside the gear case; and
a clamped part extending in a direction intersecting with the axial direction of the rotating shaft and clamped by the motor case and the gear case.

3. The motor device as claimed in claim 2, wherein
the body part is electrically connected to a gear cover made of metal that closes an opening provided at the gear case made of resin.

4. The motor device as claimed in claim 2, wherein
the gear case has a protrusion that is crushed by the clamped part.

5. The motor device as claimed in claim 2, wherein
the conductive member comprises a claw part that is hooked to the gear case.

6. The motor device as claimed in claim 2, wherein
the clamped part is inclined with respect to both the axial direction of the rotating shaft and a direction orthogonal to the axial direction of the rotating shaft.
